(19) United States
(12) Patent Application Publication
(10) Pub. No.: US 2006/0198280 A1
(43) Pub. Date: Sep. 7, 2006

(54) Phonographic Tone Arm

(76) Inventor: Nichol Cong Huynh, Midwest City, OK (US)

Correspondence Address: NICHOL HUYNH, 505 HARR DR., # G, MIDWEST CITY, OK, 73110, US

(21) Appl. No.: 10/906,790

(22) Filed: Mar. 7, 2005

(51) Int. Cl. G11B 17/00; G11B 21/16

(52) U.S. Cl. 369/252

(57) ABSTRACT

A tone arm having one end attaches to a phonograph cartridge and the other end is a threaded rod. The tone arm has a flexible string suspension for horizontal and vertical movements. The suspension string has an upper end attached to an upper member of a frame and a lower end attached to a sleeve. The sleeve can translate and rotate lengthwise on the threaded rod end of the tone arm. The sleeve is fixed on the tone arm by means of a jam nut. The sleeve has a magnet attached to it. This magnet interacts with an opposing magnet suspended by a string within a sealed viscous liquid filled container locating on the upper member of the frame. The tone arm has a counter weight system attaches to the threaded rod end. The counterweight system consists of a second sleeve, a bar having an opening area to engage with the sleeve and a weight on opposite end. The sleeve has internal threads that engage with the threaded rod of the tone arm. The sleeve also has a groove on its outer diameter that accepts the bar. As the sleeve rotates, it moves the bar on the tone arm's threaded rod lengthwise. The bar allows relative movement between the tone arm and the counter weight. The tone arm also has string and weight as an anti skating device. The frame has four openings, two on the upper member and two on the lower member. The upper two openings are located at the opposite end walls of the upper member of the frame. The two lower openings are located at the opposite end walls of the lower member of the frame. There is one rod per side with matching shape to the opening engaging the two openings on each end of the frame. The two rods is firmly attached to a base. The rods and the openings arrangement provide stable vertical motions for the frame carrying the tone arm. There is a threaded rod fits through an opening in the lower member of the frame. A nut on the threaded rod is a means to raise and lower the frame. This allows stable vertical tracking adjustment during record playing. The base attaches the tone arm assembly to the turntable by normal means.

### BRIEF SUMMARY

This invention is an improvement for tone arm supporting and damping for playing record. The improvements are relating to US patent by Firebaugh and Germany Patent by Shroder. The viscous damping material in this invention is sealed in a container preventing spillage, an improvement over Firebaugh patent. The magnets in this invention are movable eliminating tedious magnetic fields alignments, an improvement over Shroder invention. The magnet attaching to the tone arm has rotation and translation movements lengthwise of the tone arm. The rotational motion of the arm with respecting to its magnet allows the azimuth adjustment of the tone arm possible without disturbing the gap between the magnets. This allows the Vertical Tracking Adjustment (VTA) remaining constant. The translation movement of the magnet on the tone arm allows adjustable tone arm effective lengths by means of a spacer. The string suspension of the opposing magnet eliminates the anti skating force resulting from rotational movements of one magnet with respect to a second fixed magnet. In this invention, the opposing magnet moves freely with the magnet on the tone arm resulting little or no anti skating effects on the tone arm.

The flexible bar connecting the counter weight to the tone arm allows relative movements between the counter weight and the tone arm. The relative movements between the counter weight and the tone arm act as a damping device. The stylus force acts on the tone arm first then the flexible bar relays the same force to the counter weight. The flexible bar causes the counter weight to move slightly out of synch as of the tone arm. This out of synch condition dissipates the stylus energy.

In the drawing:

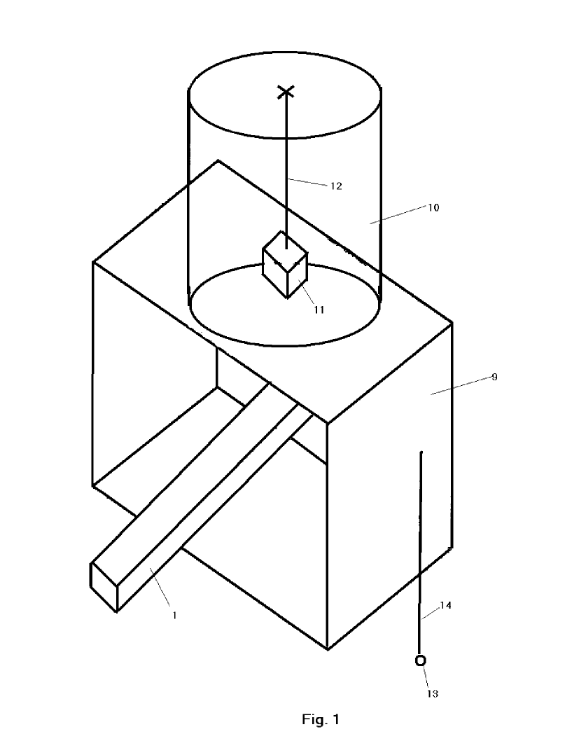

FIG. 1 is a perspective view of a tone arm and an opposing magnet suspended by a string within a sealed viscous liquid filled container locating on the upper member of a frame.

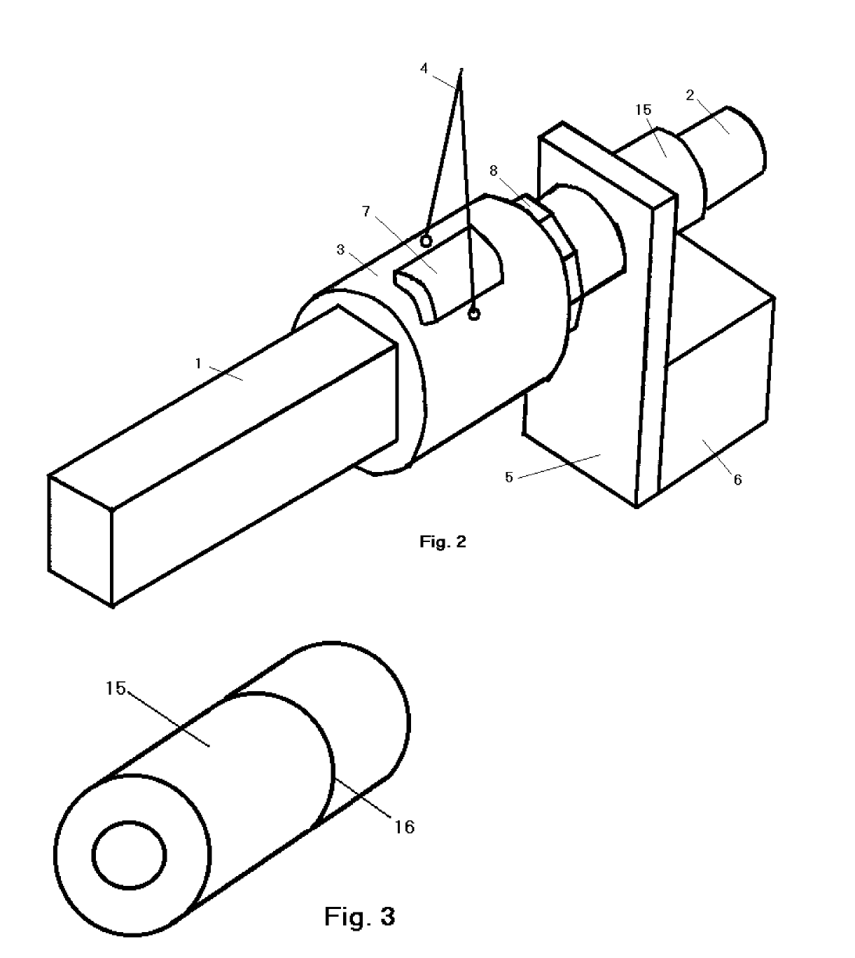

FIG. 2 is a perspective view of an arm wand with its components.

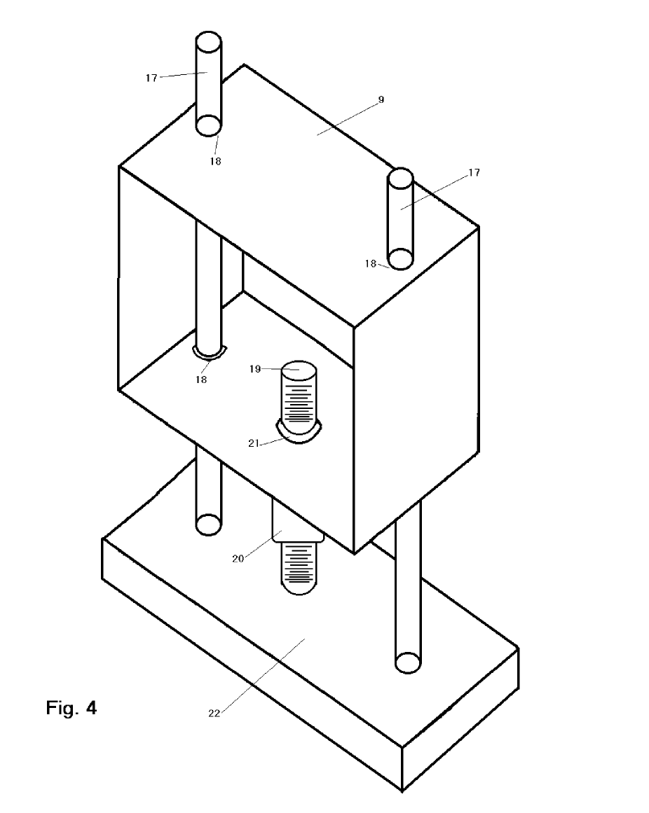

FIG. 3 is a perspective view of a sleeve of a counter weight system.

FIG. 4 is a perspective view of the tone arm supporting system.

### DETAILED DESCRIPTION

From FIG. 1, an arm wand 1 is locating within a frame 9 supports a sealed viscous liquid filled container 10 containing an opposing magnet 11 suspended by a string 12. The arm wand 1 also has an anti skating device consists of a string 14 and a weight 13.

From FIG. 2, an arm wand 1 has a threaded rod 2 at one end. The threaded rod 2 carries a sleeve 3, a jam nut 8, and a counterweight system consisting of a sleeve 15, a flexible bar 5, and weight 6. The sleeve 3 rotates and translates along the length of the threaded rod 2. The jam nut 8 fixes the sleeve 3 to the arm wand 1. The sleeve 3 also has a magnet 7 and string 4 attach to it. The sleeve 15 carries the flexible bar 5 with a weight 6 on the threaded rod 2. A flexible string 4 connects the arm wand 1 to the upper member of the frame 9.

From FIG. 3 shows sleeve 15 with a groove 16 that the flexible bar 5 rides on.

From FIG. 4 shows the frame 9 has four openings 18, two on the upper member and two on lower member. The upper two openings 18 are located at the opposite end walls of the upper member of frame 9. The two lower openings 18 are located at the opposite end walls of the lower member of frame 9. There is one rod 17 with matching shape to the opening 18 per side engaging the two openings 18 on each end of the frame 9. The two rods 17 is firmly attached to base 22. The rods 17 and openings 18 arrangement provide stable vertical motions for the frame 9 carrying the tone arm 1. There is a threaded rod 19 fits through an opening 21 in frame 9. A nut 20 on the threaded rod 19 is a means to raise and lower the frame 9. This allows stable vertical tracking adjustment during record playing. The base 22 attaches the tone arm assembly to the turntable by normal means.

What is claimed is:

1. A tone arm device for playing record, comprising:
An arm wand made to carry a cartridge at one end and a threaded rod at the other end, a sleeve engaging with said threaded rod having a magnet and a flexible string attached to it, said flexible string attaches said arm wand to a frame, a jam nut fixing said sleeve to said arm wand, a counterweight system consisting a second sleeve having a groove on its circumference, a flexible bar having an open area at one end to engage with said groove of said sleeve and a weight on its opposite end.

2. A tone arm assembly is also comprising:
A second opposing magnet is suspended by a string inside a sealed viscous liquid or air filled container locating on the upper member of said frame. Said tone arm assembly also has anti skating device consisting of a string and a weight.

3. A tone arm supporting system for a tone arm comprising:
Said frame has four openings, two on the upper member and two on lower member. Said upper two openings are located at the opposite end walls of said upper member of said frame. Said two lower openings are located at the opposite end walls of said lower member of said frame. There is one rod with matching shape to said openings per side engaging said two openings on each end wall of said frame. Said two rods is firmly attached to a base. There is a threaded rod fits through an opening in said lower member of said frame. A nut on said threaded rod is a means to raise and lower said frame.
